(19) United States
(12) Patent Application Publication
(10) Pub. No.: US 2013/0298721 A1
(43) Pub. Date: Nov. 14, 2013

(54) GRIP FOR HANDLEBARS

(71) Applicant: David J. REPPERT, Saratoga Springs, NY (US)

(72) Inventor: David J. REPPERT, Saratoga Springs, NY (US)

(21) Appl. No.: 13/891,370

(22) Filed: May 10, 2013

Related U.S. Application Data
(60) Provisional application No. 61/646,065, filed on May 11, 2012.

(51) Int. Cl. B62K 21/26

(52) U.S. Cl. CPC B62K 21/26
USPC 74/551.9

(57) ABSTRACT

A grip for handlebars has a planar sheet of neoprene rubber, an embossed layer, or sheet, upon the exterior of the sheet, and a strip of hook releasable fastener upon one edge. The sheet has a generally rectangular form having four edges. An edge is about four inches and may extend to about twenty four inches. The sheet has an upper surface and a lower surface where the upper surface appears visible upon installation. The lower surface includes loop releasable fastener and receives the strip during installation. Further, the strip of hook fastener secures to the sheet through industrial stitching and a triple lock stitch and has adhesive suitable for many temperatures. The strip has an offset ½ inch wide that exposes a strip of hook fastener for later securement to the lower surface upon wrapping the sheet around a factory grip.

### CROSS-REFERENCE TO RELATED APPLICATION

This non-provisional application claims priority to the pending provisional application 61/646065 filed on May 11, 2012 which is owned by the same inventor.

### BACKGROUND OF THE INVENTION

The grip for handlebars relates generally to accessories for handles upon vehicles, equipment, and machinery, and more specifically to a sheet wrapped around a factory grip or other round or bar shaped handle. A rider, operator, or user can readily install the invention.

From dealers, shops, and other persons, people buy motorcycles, vehicles, equipment, and machinery, and become riders, operators, and users. A rider steers a motorcycle using the handlebars at the front of the motorcycle. The handlebars have a generally linear, elongated form with two outward ends. Upon the ends, the handlebars have factory grips, and occasionally an after market grip. The left grip remains fixed upon the handlebars though the right grip rotates coaxially with the axis of the right portion of the handlebars. The rotation of the right grip allows the rider to control or throttle the engine of the motorcycle.

A rider though keeps at least one hand and preferably two hands upon the grips during a ride. Riders often seek the open road and take long rides upon their motorcycles usually upon roads, but sometimes upon rough terrain. The Iron Butt Association sponsors rallies each year for distances in excess of 900 miles within twenty four hours. After a while on a long ride, a rider's hands may tire of closing their fingers upon the grips. Riders may flex their fingers or remove one hand at a time from the handlebars. Though these behaviors limit or reduce finger and hand cramping, these behaviors raise the risk of the rider losing control of the motorcycle. Skilled riders minimize this risk, but the risk still remains.

Other vehicles and equipment have handles grasped by their operators and users for extended time periods, repetitive cycles, and in select environmental conditions. Various delivery vehicles include handles proximate the front entry point, the back hatch and rear bumper. These handles allow a delivery person to enter the driving cabin, and to climb on and off the rear bumper as needed to make a delivery. The delivery vehicle handles may have a round cross section, or bar cross section formed into a general S shape or C-like shape and attached to the bumper and vehicle body. Delivery persons grip the handles with each stop they make and when a single stop has multiple deliveries. With repetitive gripping on the handles, a delivery person's hand may tire and put a firm, safe grip upon the handle at risk. Along with delivery trucks, vehicles that have a person grasping a portion of the vehicle include bicycles, snowmobiles, personal watercraft, recreational boats, golf carts, recreational vehicles, air craft, and the like. Along with vehicles, people also grasp handles upon machinery and equipment for extended periods. Handles appear upon lawn mowers, edgers, logging equipment, mining machines, and like equipment where an operator has hands on control of the equipment or machine. After a long enough time gripping a handle, a person's hand tires and a safe, strong grip thus weakens and becomes compromised.

### DESCRIPTION OF THE PRIOR ART

Traditionally, manufacturers have provided grips upon the handlebars of their motorcycles, vehicles, and other equipment. The factory grips have a generally cylindrical shape and limited cushioning. The grip shape has a generally constant diameter, proportional to the handlebar diameter. The cylindrical shape may not account for differentials in finger positioning of the rider when closed. Closed fingers generally occupy a somewhat arcuate shape as opposed to a right cylinder. On a long ride, the fingers of a rider notice the cylindrical grips and select fingers may ache as they fit poorly upon a cylindrical grip. Manufacturers have responded with grooves in grips to aid ventilation and to aid deflection and compression of the grip to approximate the fingers and after market suppliers have provided many kinds of grip cushions. However, such modification must keep in mind rider control of the motorcycle and rider safety.

Prior art suppliers have utilized neoprene sleeves and open cell foam formed into cylindrical shape. The prior art sleeves have utilized a cushioning material for user comforter in doing so though, the sleeves have become pervious to water. The sleeves though detached from the factory grips in time, prematurely for many riders. The sleeves rotated upon the factory grips putting the rider's ability to control at risk. Riders also had to exert additional gripping force when compressing the sleeves to grasp the underlying factory grip. Along with rotation, prior art sleeves would migrate inwardly and outwardly upon the factory grip.

The prior art has sleeves and cylinders of many materials to fit over factory grips on motorcycles, other vehicles, and equipment. However, the prior art shares the common disadvantage of slippage of the accessory upon the factory grip. Slippage leads to excessive rider gripping, finger aches, and possibly compromising of throttling or steering. Excessive gripping deflects the prior art grip accessories leading to formation of plastic hinges in the accessories and premature wear of the accessories or separation of the accessory from the grip. For riders sensitive to hand comfort and the appearance of their handlebars, grip accessories that fall apart or separate are not acceptable.

The present invention overcomes the difficulties of rider hand and finger cramping and separation of an accessory from a grip.

### SUMMARY OF THE INVENTION

Generally, the present invention provides a grip for handlebars, typically provided in pairs. The invention utilizes a sheet of neoprene rubber having four edges, a blended or pure rubber embossed layer, also called a skin, upon the exterior of the neoprene rubber sheet, and a strip of one portion of releasable fastener upon one edge of the sheet. The invention has a thickness between about 0.5 mm to about 8 mm that varies upon the motorcycle model of the rider, the machine environment, and the handle cross section needing the grip. The sheet has a generally rectangular form having four edges: two mutually parallel and spaced apart lateral edges and two mutually parallel and spaced apart longitudinal edges perpendicular to the lateral edges. The minimum length of an edge is about four inches and the maximum edge length is about twenty four inches. The sheet has an upper surface and a lower surface where the upper surface appears visible to a rider upon installation of the invention upon a grip. is The lower surface receives a strip of adhesive backed hook fastener upon one edge. Further, the strip of hook fastener secures to the sheet through industrial stitching with a triple lock stitch using thread such as B-69 nylon. The strip has an offset of ½ inch wide that exposes a strip of hook fastener for later securement to the lower surface upon wrapping the sheet around a factory grip. The invention has endured focus group scrutiny and testing from the rider community. The rider community has put the invention through multiple environments on the road such as hot, cold, wet, damp, fog, ice, and the occasional collision.

There has thus been outlined, rather broadly, the more important features of the invention in order that the detailed description thereof that follows may be better understood and that the present contribution to the art may be better appreciated. The present invention also includes select embossment patterns upon the outer surface, additional passes of stitching at the ends of the strip, water proof adhesive, gasoline resistant adhesive, oil resistant adhesive, an adhesive stable at temperatures upwards of 230° F., and various colorations. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved grip for handlebars.

Another object is to provide such a grip for handlebars that does not separate from the existing grips following installation.

Another object is to provide such a grip for handlebars that cushions the hands of a motorcycle rider or other user.

Another object is to provide such a grip for handlebars that improves the feel and comfort a motorcycle rider or other user experiences in his hands.

Another object is to provide such a grip for handlebars that does not absorb water and has a heightened coefficient of friction when wet.

Another object is to provide such a grip for handlebars that improves the sensation of control, that is, close contact control, by the motorcycle rider, or other user, as the grip fills gaps between his fingers, his palms, and the grip.

Another object is to provide such a grip for handlebars that operates in a compatible manner with heated factory grips as it transmits heat from the factory grips to the rider's hands during cold weather.

Another object is to provide such a grip for handlebars that operates in a compatible manner with heated factory grips as it transmits heat from the factory grips preventing accumulation of frost or ice upon the grips.

Another object is to provide such a grip for handlebars that does not migrate, rotate, or slip around the factory grips.

Another object is to provide such a grip for handlebars that is durable and long lasting.

Another object is to provide such a grip for handlebars that installs upon other motorized vehicles, delivery vehicles, bicycles, fixed equipment, engine powered equipment, mobile equipment, select watercraft, and select aircraft.

Another object is to provide such a grip for handlebars that can be easily and readily installed by riders, mechanics, operators, users, and unskilled labor.

Another object is to provide such a grip for handlebars that can be easily and efficiently manufactured and marketed to the consuming public.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows a top view of the invention;

FIG. 2 shows a bottom view of the invention;

FIG. 3 describes a sectional view of the invention;

FIG. 4 illustrates a side view of the invention;

FIG. 5 provides a perspective view of installation of the invention; and,

FIG. 6 shows a back view of the invention as installed;

FIG. 7 shows a perspective view of an alternate installation of the invention;

FIG. 8 provides a perspective view of an alternate installation of the invention;

FIG. 9 provides a perspective view of an alternate installation of the invention; and,

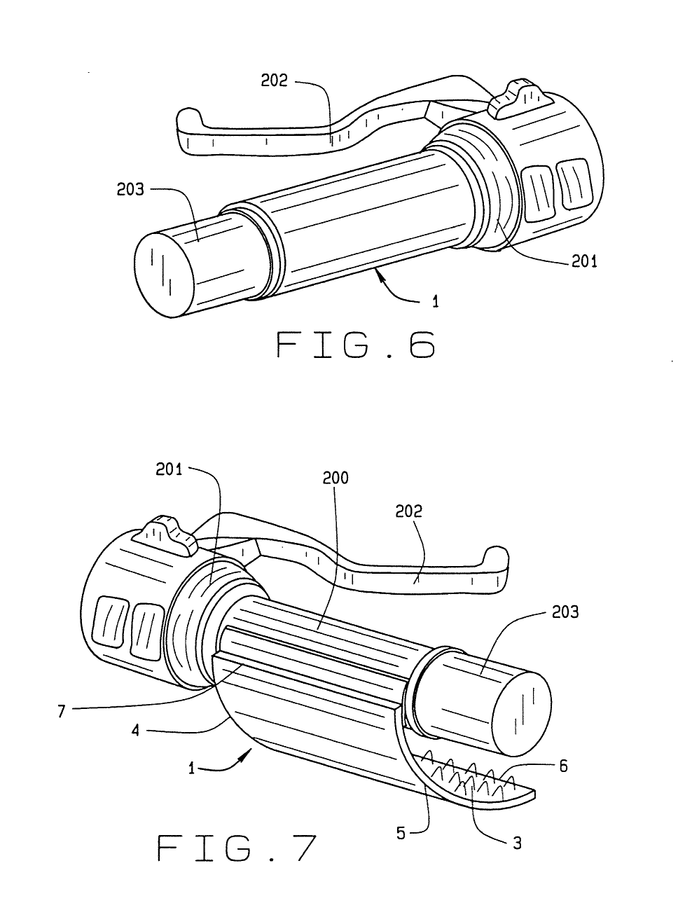

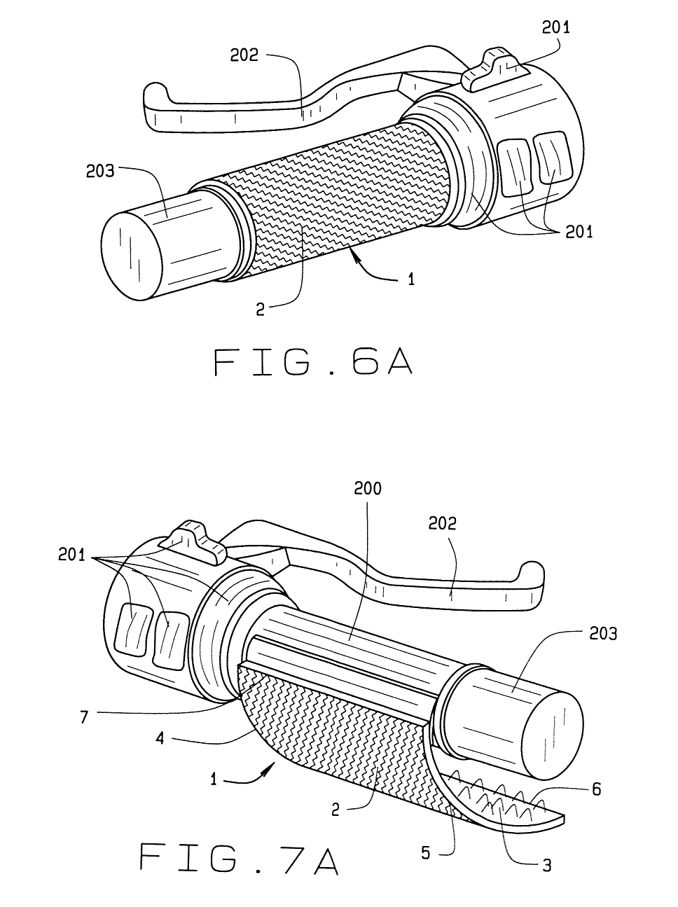

FIGS. 6a, 7a show a back view and a perspective view of invention with the embossments outwardly.

The same reference numerals refer to the same parts throughout the various figures.

### DESCRIPTION OF THE PREFERRED EMBODIMENT

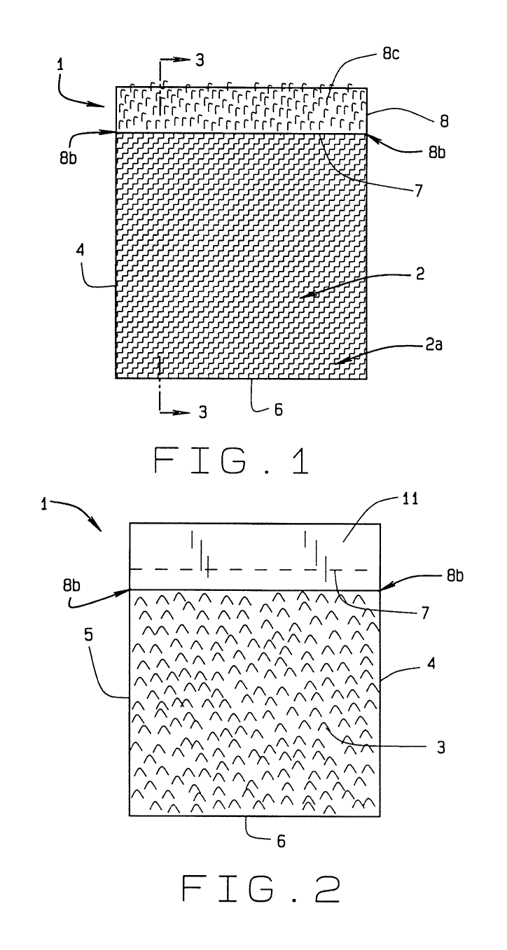

The present invention overcomes the prior art limitations by providing a grip that installs upon a factory grip benefitting the fingers and hands of a rider who closes his fingers upon the grip. Though this description and the figures often refer to a motorcycle, the Applicant foresees placement and installation of the invention upon other vehicles and equipment. The references to a motorcycle, its grip, and its handlebars serve as examples because the invention installs upon other vehicles, machinery, ladders, and equipment with handles. Beginning on FIG. 1, the grip 1 of the invention has a generally planar, sheet like form when shown in flat form. The sheet of the invention 1 is flexible and elastic. The grip has a generally rectangular form with an upper surface 2 and an opposite lower surface 3 as shown in FIG. 2, an inner edge 4 and a mutually parallel and spaced apart outer edge 5, both edges being longitudinal. The outer edge has its location away from the center of the motorcycle handlebars upon installation as later shown in FIGS. 5, 6. Spanning between the inner edge and the outer edge, the sheet has its free edge 6. Opposite the free edge and mutually parallel to the free edge, the sheet has its seam 7 where a strip 8 of releasable fastener connects to the sheet. The free edge and the seam are generally lateral edges, that is, perpendicular to the longitudinal edges of the inner edge and the outer edge. The inner edge, outer edge, and free edge have a length of about 4 inches to about 24 inches.

The strip 8 generally has the male portion of hook and loop fastener, is preferably the hook portion 8c. Such hook portion of the fastener is made by Velcro Industries B.V. of the Netherlands and its units around the world, including Velcro USA of Manchester, N.H. The hook portion extends outwardly from the strip and generally upwardly in the same direction as the upper surface 2 of the sheet. The strip has a preferred width of about one inch with approximately ½ inch of its width underlapping the lower surface. The strip permanently secures to the sheet by mechanical stitching. The stitching 8a binds the strip directly to the lower surface and to the upper surface indirectly using industrial thread, preferably B-69 nylon, often used for automotive or upholstery applications. The stitching extends along the length of the strip as it underlaps the lower surface of the sheet opposite the free edge. Preferably at the initiation and termination of the stitching, the stitching includes a triple lock stitch 8b. The triple lock stitches have positions proximate to the outer edge and inner edge. In an alternate embodiment, the hook and loop fastener has a vinyl based composition which makes less sound upon separation of the loop from the hook fastener.

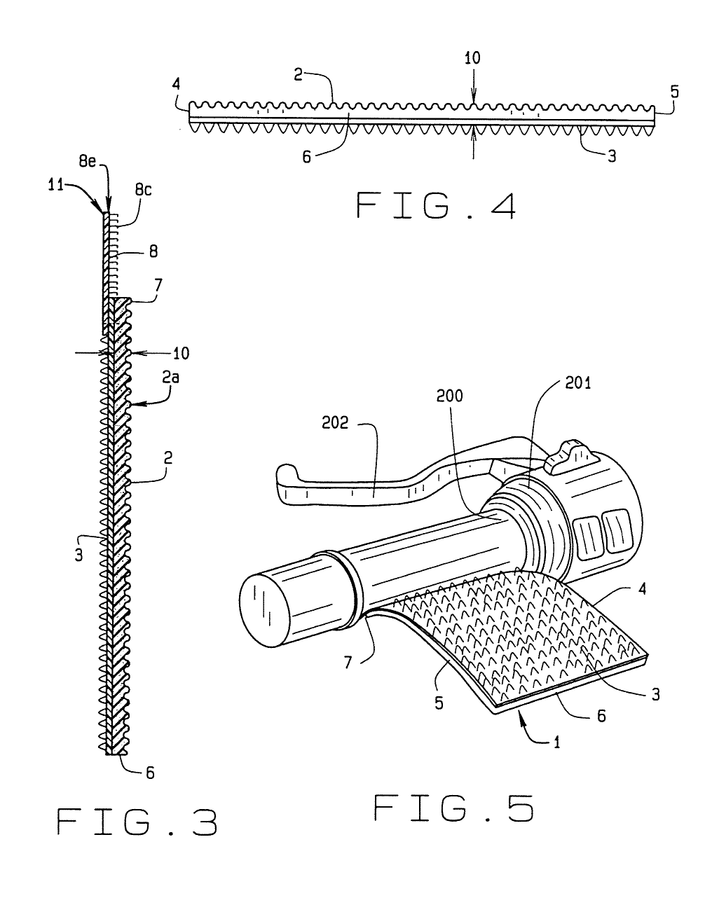

Inwardly from the strip, the upper surface 2 has a surface treatment comfortable yet functional for a rider of a motorcycle using this invention on his bike. Here, the upper surface has a pattern of offset raised ridges. The ridges have a height less than 25% of the thickness 10 of the sheet as later shown in FIGS. 3, 4. The raised ridges have a generally flat top outwardly from the upper surface with the top approximately 50% of the length of a ridge.

Opposite the hook portion 8c, the strip 8 has its adhesive 8e beneath a release layer 11 as shown in FIG. 2. The adhesive may include pressure sensitive or heat sensitive and the strip may include a vinyl substrate. FIG. 2 shows a bottom view of the invention with the lower surface 3 visible. The lower surface also has the inner edge 4, the outer edge 5, and the free edge 6. The lower surface includes releasable fastener upon the entire lower surface, preferably the loop portion 8d, that cooperates with the hook portion of the strip, later during installation. The lower surface has the loop portion of the releasable fastener integral with the material of the sheet. Opposite the free edge, the lower surface has the strip 8 joined to the sheet with stitching 8a upon the seam 7. Because of the overlap of the strip, the release layer 11 extends inwardly from the seam towards the center of the lower surface. The release layer extends approximately ½ inch beyond the seam.

FIG. 3 shows a section view through the sheet 1 lengthwise, that is, parallel to the inner edge and the outer edge. The release layer 11 covers the adhesive 8e upon a surface of the strip opposite the hook 8c. Prior to installation, a user separates the release layer from the adhesive so that the strip provides the first securement of the invention to a factory grip as later shown in FIG. 5. The adhesive is water proof, stable at temperatures upwards of 230° F., resistant to alcohols, and resistant to gasoline, oil, and other petroleum based products. Above the adhesive, the strip itself supports the hook portion as at 8c with the hooks extending upwardly towards the upper surface 2. The strip connects to the sheet proximate the lower surface 3 opposite the free edge 6. The strip has its stitched connection as previously described that forms the seam 7 with the sheet. Outwardly from the seam and away from the strip, the sheet has its upper surface 2 with the pattern of embossments, as at 2a, thereon. Opposite the seam, the upper surface ends at the free edge 6. The free edge has its own height that defines the thickness of the sheet as at 10. The thickness represents the spacing between the upper surface and the lower surface, preferably about 0.5 mm to about 8 mm. Spaced beneath the upper surface, the sheet has the lower surface 3 with the loop portion 8d of the releasable fastener. The loop portion spans across the entire lower surface as it is an integral condition of that surface. The loop portion extends from the inner edge to the outer edge and from the free edge to beneath the strip.

Turning the sheet, FIG. 4 shows a side view of the invention with the free edge 6 in the foreground. The free edge has a generally rectangular form with the sheet thickness 10 bounded by the inner edge 4 and the outer edge 5. The pattern of embossments 2a continues upon the upper surface 2. While the lower surface 3 has its loop portion 8d of the releasable fastener. The loop portion extends from the inner edge to the outer edge and away from the free edge. The pattern of embossments has symmetry upon two axes so that the embossments appear similar in FIGS. 3, 4. A user views the free edge in preparation for installing the device.

Installation begins as shown in FIG. 5. A rider, operator, or other user steadies the handlebars of a motorcycle, vehicle, or other equipment and then assures that motorcycle ignition is in the OFF position and that the motorcycle has solid support upon its side or center stand. The rider then finds his naturally comfortable position for his hands when riding, and notes where his fingertips fall upon the factory grip so he can position the eventual seam 7 of the strip 8 as it engages the lower surface 3, that is, just below and behind this point just behind where his finger tips will rest, without touching the seam, for maximum comfort. The rider then positions the sheet 1 near a factory grip 200. The factory grip has its original surface texture, materials, and groove pattern. The factory grip may have adjacent controls 201 and a nearby handle 202 such as for braking or actuating the clutch of the motorcycle (not shown). Keeping in mind the position of the controls 201, the rider removes the sheet from its shipping packaging, inverts the sheet so that the lower surface 3 is upwardly, that is, towards the rider, and orients the free edge 6 towards the rider, here in the foreground of the figure. This positions the inner edge towards the controls and the outer edge away from the controls, that is, away from the center of rotation of the handlebars. The rider the pulls the release layer 10 exposing the adhesive 8e of the strip. Effectively, the rider peels the release layer from the adhesive provided with the strip and that has withstood the stitching. The release layer generally pulls away readily from the stitching. The rider then positions the seam 7 generally beneath the factory grip 200 and slightly towards the rider, approximately 1/10 of a rotation. The Applicant suggests these seam positions: when viewing the end of the right handlebar, the seam appears at 7 o'clock and when viewing the left handlebar's end, the seam appears as 5 o'clock. The rider then presses the strip against the grip evenly so that the adhesive 8e adheres the grip 1 to the factory grip 200 or just handlebars if so equipped. The rider then has the lower surface towards the grip to catch the hook portion.

The rider then wraps the sheet upon the factory grip 200 by bringing the free end up, toward the rider, and around the grip towards the handle 202. The adhesive retains the sheet in position upon the factory grip or handlebars so that a rider may stretch the sheet. The rider tugs at the sheet gently during installation so it stretches and has a snug fit upon the factory grip. The rider brings the sheet around the grip, as in FIG. 6, so that the lower surface 3 approaches the hook portion of the strip. The rider then tugs the lower surface once more then places the loop portion 8e of the lower surface upon the hook portion 8d of the strip 8. The rider then presses upon the lower surface where the inner edge meets the free edge and where the outer edge meets the free edge. Doing so secures the lower surface to the strip at two spaced apart points, that is, corners, of the sheet. Beneath the engaged hook and loop fastener, the adhesive prevents the sheet from rotating and migrating relative to the factory grip. After positioning the adhesive 8e so that the resulting joint of the free edge upon the lower surface falls just ahead of the rider's fingertips, stretch the free edge, or non-strip edge, of the sheet under the factory grip and curl the neoprene of the sheet back over the top of the sheet placed upon the factory grip, pressing the free edge down to the hook strip so it butts up to the free edge opposing edge of the neoprene, by first lining up the extreme left and right edges of the seam, then working toward the center. The Applicant foresees riders or other installers stretching and re-positioning the joint of the free edge upon the lower surface progressively, so that both edges of the joint come together evenly. The rider then presses the lower surface between those two spaced apart points moving from them towards the center of the factory grip. Doing so provides a smooth, tight fit of the lower surface upon the securing hook portion 8c. As a reminder during installation, a rider is to completely cover the hook portion 8c with the loop portion 8c but do not overlap the free edge 6 beyond the seam 7. The rider then has a snug, comfortable grip 1 upon a factory grip 200, ready to ride on the handlebars 203 of a motorcycle. The grip of the invention follows the contours of the factory grip or the handlebars themselves. Though this description mentions a rider, the installer of the grip may also be a mechanic, operator, user, driver, and the like.

Similar to FIG. 5, FIG. 7 shows an alternate method of installation. The rider begins the installation by removing the release layer and securing the seam to the factory grip away from the handle, that is, opposite that shown in FIG. 5. The rider then wraps the sheet upon the factory grip 200 by bringing the free end up, away from the rider, inside of the handle 202, and around the grip towards the rider. This installation positions the seam beneath the location that would intersect with the palm of the rider.

As a word to the wise, after installing the present invention upon the handlebars and before starting the motorcycle, vehicle, or equipment, the rider should check and verity the normal free operation of the throttle, clutch, or other controls upon the handlebars of the motorcycle. Further, upon completing installation of the invention 1 upon the right handlebar of a motorcycle, prior to starting of the motorcycle, the rider manually twists the throttle several times to verify the free play, and that it easily returns to its spring-loaded starting position, without any resistance. Having checked for proper operation of the throttle, clutch, or other controls, the rider may use the motorcycle normally.

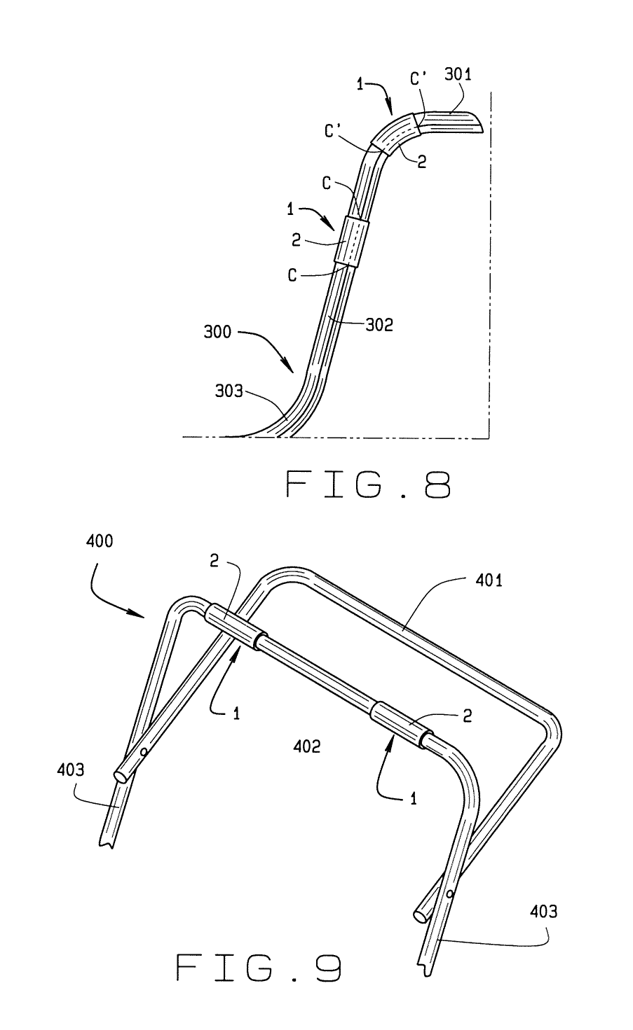

Turning to FIG. 8, this figure shows an alternate installation of the invention upon a handlebar, commonly seen upon a package delivery truck. This handle bar, as at 300, has a generally S like shape with an upper curve 301 extending into a vertical elongated portion 302 which then turns into a lower curve 303, or alternately a C-like shape. The present invention 1 utilizes its sheet form so that a driver or other user of the handlebar may grasp the handle comfortably yet securely. The present invention installs readily upon the elongated portion 302 by wrapping the invention 1 upon the portion so that the upper surface 2 faces outwardly as previously described. The installer positions the invention at a convenient height within the elongate portion. The invention readily accommodates an edge as in a handlebar with a rectangular cross section, here shown by the line cc. Also, an installer may position the present invention upon a curve of this handlebar as shown towards the upper curve 301 in this figure. The flexibility and elasticity of the invention—akin to its warp and woof—allows it to stretch upon a convex portion of a curve and to contract upon a concave portion of a curve. When installed upon a curve in a handlebar, the present invention retains it water impermeability. Even upon a curve, the present invention accommodates an edge of the handlebar here shown along line c′c′, that is, towards the top of this figure. Though this description refers to a delivery truck, the present invention may install upon other vehicles, equipment, ladders, and machinery that has curves within handlebars.

And, a handle of a piece of equipment appears in FIG. 9. Equipment, such as a walk behind lawn mower for example, often has an elongated handle. Such a handle, as at 400, allows an operator to grasp the equipment from a standing position and with limited bending of the operator's back. An operator though may grasp the handle 400 for extended time periods on bigger jobs, for example, a large lawn. The exemplary lawnmower handle 400 has two mutually parallel and spaced apart rails as at 403 spanned by a bar 402 at the ends of the two rails. Present day walk behind lawnmowers come equipped by the factory with a safety brake, generally engaged upon the mower's engine, unless the operator releases the brake by grasping a safety bar as at 401 upon the bar 402. The safety bar has a pivotal connection to the handle 400 and a cable connection to the brake upon the engine. Generally, operators use two hands to push a walk behind lawnmower which provides a straight application of motive force to the mower and allows the operator to initiate turning the mower during usage. An operator may install one, or preferably two, of the present invention 1 upon the bar 402 with the upper surface 2 shown outwardly. The installation method is as described previously. The thickness of the invention, as at 10, and the resilience of its material allow an operator to close the safety bar 401 upon the bar 402 and operate the mower normally, that is, as if the invention was not installed. Though this figure shows a safety bar 401, this description also applies to other forms of safety lockout devices related to handles upon various equipment and vehicles.

FIGS. 6a, 7a show the invention installed upon a grip and an alternate installation of the installation with the pattern of embossments, as at 2, outwardly. The embossments assist the user in firmly gripping the invention 1 when installed and during usage in various conditions encountered.

The preceding description and figures often referred to a motorcycle. The references to a motorcycle, its grip, and its handlebars serve as examples because the invention installs upon other vehicles, machinery, ladders, and equipment with handles. Such vehicles and equipment include without limitation delivery trucks, walk behind lawnmowers, other walk behind lawn equipment, other walk behind power equipment, ride upon power equipment, snowmobiles, personal watercraft, aircraft, boats, machinery fixed in place, mobile machinery, ladders, cat walks, logging equipment both powered and not powered, mining equipment both powered and not powered, construction equipment whether powered or not, and the like.

From the aforementioned description, a grip for handlebars has been described. The grip for handlebars is uniquely capable of securing a flexible, comfortable material upon factory grips of a motorcycle, or other vehicle with handlebars, without compromising the control and the steering of a rider. The grip for handlebars and its various components may be manufactured from many materials, including but not limited to, polymers, polyvinyl chloride, high density polyethylene, polypropylene, nylon, ferrous and non-ferrous metals, their alloys, and composites. Preferably, the sheet is neoprene rubber, or chloroprene rubber, the upper surface includes pure rubber or blended rubber, and the releasable fastener of the strip and the lower surface includes hook and loop fasteners in cooperating portions as described.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like -when they appear- are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several is purposes of the present invention. Therefore, the claims include such equivalent constructions insofar as they do not depart from the spirit and the scope of the present invention.

I claim:

1. A device to grasp handlebars, comprising:
a sheet, generally flexible, elastic, and planar, said sheet having an upper surface and an opposite lower surface spaced apart by a thickness, an inner edge and a mutually parallel and spaced apart outer edge, a free edge spanning said inner edge and said outer edge, a strip of releasable fastener secured to said lower surface opposite said free edge and mutually parallel to said free edge, and a stitched seam of said strip to said lower surface;
wherein said sheet folds inwardly into a generally cylindrical form and is adapted to follow the contours of the cross section of the handlebars.

2. The grasp device of claim 1 further comprising:
said strip having an hook portion of releasable fastener oriented towards said upper surface; and,
said lower surface having integral unbroken loop portion of releasable fastener wherein said loop portion cooperatively engages said hook portion upon installation of said grasp device thus enwrapping the handlebars.

3. The grasp device of claim 2 further comprising:
said lower surface having an adhesive layer generally opposite said strip;
wherein said loop portion extends upon more of said lower surface than said adhesive layer and a release layer outwardly upon said adhesive layer; and,
wherein said adhesive is adapted to bond to the handlebars.

4. The grasp device of claim 1 further comprising:
said seam being formed from a triple lock stitch; and,
said upper surface having a pattern of embossments, wherein said embossments are adapted to extend outwardly from the handlebars.

5. The grasp device of claim 3 wherein said adhesive layer is waterproof, resistant to gasoline, oil, and alcohol, and temperature stable to 230° F. and said sheet is one of neoprene, chloroprene rubber, pure rubber, and blended rubber.

6. A device to grasp handlebars, comprising:
a planar, flexible, elastic sheet having an upper surface and an opposite lower surface spaced apart by a thickness, an inner edge and a mutually parallel and spaced apart outer edge, a free edge spanning said inner edge and said outer edge, a releasable fastener strip secured to said lower surface opposite said free edge and mutually parallel to said free edge, said releasable fastener strip having an hook portion oriented towards said upper surface and a cooperating loop portion upon said lower surface, and a stitched seam of said releasable fastener strip to said lower surface;
said lower surface having an adhesive layer generally opposite said releasable fastener strip, wherein said loop portion extends upon more of said lower surface than said adhesive layer and a release layer outwardly upon said adhesive layer;
wherein said sheet folds inwardly into a generally cylindrical form and is adapted to follow the contours of the cross section of the handlebars;
wherein said adhesive is adapted to bond to the handlebars; and,
wherein said loop portion cooperatively engages said hook portion so said device grasps and enwraps the handlebars.

7. The grasp device of claim 6 further comprising:
said seam being formed from a triple lock stitch;
said upper surface having a pattern of embossments adapted to extend outwardly from the handlebars; and,
said adhesive layer being waterproof, gasoline resistant, oil resistant, alcohol resistant, and temperature stable to 230° F.

8. The grasp device of claim 6 wherein said sheet is one of neoprene, chloroprene rubber, pure rubber, and blended rubber.

9. A device to grasp handlebars, comprising:
a planar, flexible, elastic sheet having an upper surface and an opposite lower surface spaced apart by a thickness, an inner edge and a mutually parallel and spaced apart outer edge, a free edge spanning said inner edge and said outer edge, a strip of releasable fastener secured to said lower surface opposite said free edge, said releasable fastener having an hook portion oriented towards said upper surface and a cooperating loop portion upon said lower surface, and a seam formed from a triple lock stitch of said strip to said lower surface;
said lower surface having an adhesive layer generally opposite said strip, wherein said loop portion extends upon more of said lower surface than said is adhesive layer and a release layer outwardly upon said adhesive layer, and said adhesive layer being waterproof, resistant to gasoline, oil, and alcohol, and temperature stable to 230° F.;
said upper surface having a pattern of embossments adapted to extend outwardly from the handlebars;
wherein said sheet folds inwardly into a generally cylindrical form and is adapted to follow the contours of the cross section of the handlebars;
wherein said adhesive is adapted to bond to the handlebars; and,
wherein said loop portion cooperatively engages said hook portion so said device grasps and enwraps the handlebars.
